(19) United States
(12) Patent Application Publication
(10) Pub. No.: US 2024/0149624 A1
(43) Pub. Date: May 9, 2024

(54) 2.4G SIGNLE ENCODING WAKE-UP OPEARTION TIRE PRESSURE DETECTOR

(71) Applicant: TAI-LANG WU, TAIPEI CITY (TW)

(72) Inventor: TAI-LANG WU, TAIPEI CITY (TW)

(21) Appl. No.: 18/384,885

(22) Filed: Oct. 30, 2023

(30) Foreign Application Priority Data
Nov. 9, 2022 (TW) 111142773

(51) Int. Cl. B60C 23/04; G06K 7/10; G06K 19/077

(52) U.S. Cl. CPC B60C 23/0445; G06K 7/10366; G06K 19/07764

(57) ABSTRACT

A 2.4G signal encoding wake-up operation tire pressure detector includes a first TPMS-MCU electrically connected to a first TPMS memory unit, a first TPMS communication interface, a first TPMS main controller, and a TPMS high-frequency transceiver module. The TPMS high-frequency transceiver module includes a TPMS-BLE radio frequency unit, a TPMS-OOK radio frequency unit, and a TPMS high-frequency antenna. The TPMS-BLE radio frequency unit, the TPMS-OOK radio frequency unit, and the TPMS high-frequency antenna use a shared circuit. A second TPMS-MCU is electrically connected to a second TPMS memory unit, a second TPMS communication interface, a second TPMS main controller and the first TPMS-MCU. The first TPMS-MCU and the second TPMS-MCU do not contain TPMS low-frequency circuits or TPMS low-frequency antennas, and the low frequency is less than or equal to 150 KHz. This invention eliminates the need for using both high-frequency antennas and low-frequency antennas simultaneously.

### FIELD OF THE INVENTION

The present invention relates to a tire pressure detector that operates through 2.4G signal encoding wake-up. It utilizes high-frequency signals to trigger the TPMS (Tire Pressure Monitoring System) and enables pairing with a mobile reader that wakes up the tire pressure detector by using 2.4G signal encoding, thereby reducing the variety of antenna configurations.

### BACKGROUND OF THE INVENTION

A tire pressure is a critical value for the safe operation of a vehicle. With advancements in technology, methods for measuring tire pressure have significantly evolved. It has transitioned from manual measurement of each wheel before hitting the road to the automatic measurement and transmission of tire pressure values to a monitoring screen using various electronic devices, making it much more convenient.

For a complete tire pressure monitoring system, at least one tire pressure detector needs to be installed on each wheel, and the vehicle's main system should be equipped with a monitoring data device. Since the vehicle's wheels rotate at high speeds during operation, it is not suitable for wired communication between the tire pressure detectors and the monitoring data device. Instead, wireless signal transmission is preferred. As of now, the common approach is illustrated in FIG. 3, where the monitoring data reader and TPMS are equipped with high-frequency antennas, low-frequency antennas, BLE control circuits, and low-frequency control circuits. The operation process involves using the low-frequency antenna to transmit a signal that triggers the TPMS. Once awakened, the TPMS immediately reads voltage, temperature, pressure, and other data, responding to this data using the BLE radio frequency control circuit. The data is then received and displayed by the low-frequency trigger reader.

However, conventional tire pressure detection systems suffer from an issue of using a wide variety of antennas. For example, one TPMS system includes a high-frequency antenna and a low-frequency antenna, and for a vehicle with four wheels, it results in a total of eight antennas (four high-frequency and four low-frequency antennas). This setup undoubtedly places a significant burden on signal transmission. The present invention intends to provide a 2.4G signal encoding wake-up operation tire pressure detector to eliminate the shortcomings mentioned above.

### SUMMARY OF THE INVENTION

The present invention relates to a 2.4G signal encoding wake-up operation tire pressure detector and comprises a first TPMS-MCU electrically connected to a first TPMS memory unit, a first TPMS communication interface, a first TPMS main controller, and a TPMS high-frequency transceiver module. A second TPMS-MCU electrically connected to a second TPMS memory unit, a second TPMS communication interface, a second TPMS main controller, and the first TPMS-MCU. The first TPMS-MCU and the second TPMS-MCU do not contain TPMS low-frequency circuits or TPMS low-frequency antennas. The low frequency is less than or equal to 150 KHz.

The present invention utilizes a configured TPMS high-frequency transceiver module. After matching with the corresponding mobile reader that wakes up the tire pressure detector using high-frequency signals, the present invention can utilize high-frequency signals for transmission. In this way, the mobile reader that wakes up the present invention through 2.4G signal encoding only needs to be equipped with a high-frequency antenna. Similarly, the matching present invention only requires a TPMS high-frequency antenna. There is no need to simultaneously use high-frequency and low-frequency antennas. The present invention indeed improves the issue of excessive variety in antenna usage.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 illustrates a schematic diagram of the practical application system of the present invention;

FIG. 2 illustrates use of the practical application system of the present invention, and

FIG. 3 shows a conventional tire pressure detection system.

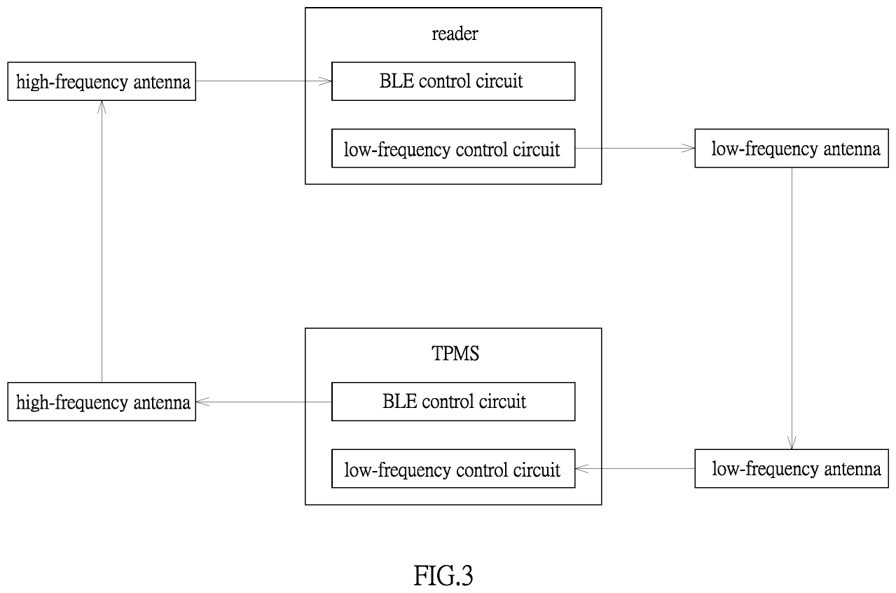

### DETAILED DESCRIPTION OF THE PREFERRED EMBODIMENT

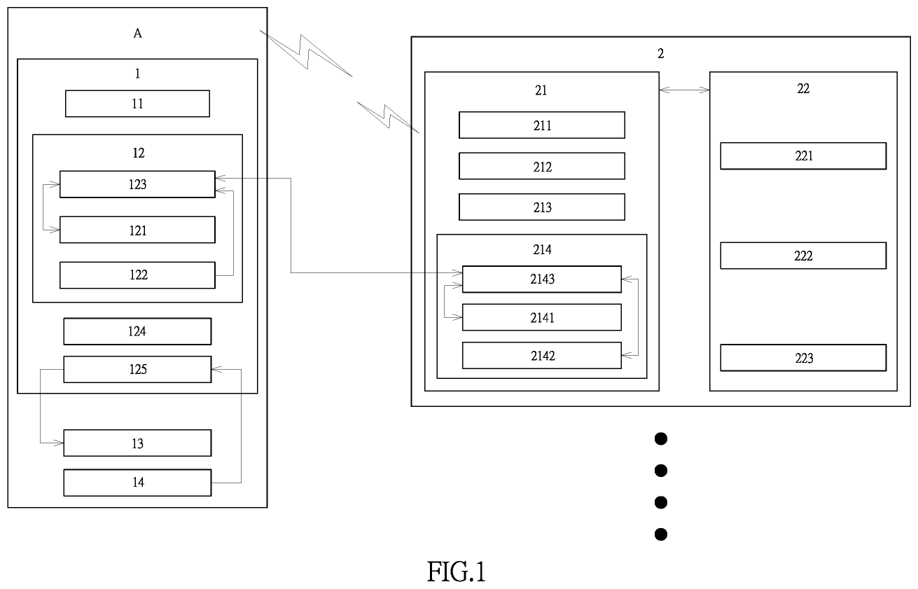

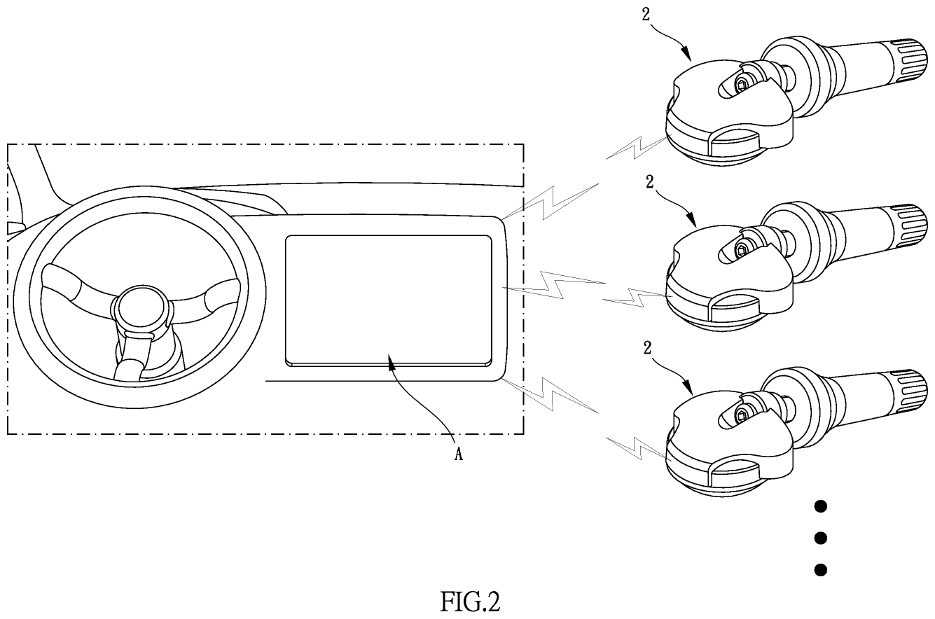

Referring to FIGS. 1 and 2, a mobile reader “A” is provided and that is cooperated with the 2.4G signal encoding wake-up operation tire pressure detector of the present invention. The mobile reader “A” comprises a reader MCU 1 (microcontroller) electrically connected to a reader memory unit 11, a reader high-frequency transceiver module 12, a reader main controller 124, and a reader input/output module 125. The reader high-frequency transceiver module 12 comprises a reader BLE radio frequency unit 121, a reader OOK radio frequency unit 122, and a reader high-frequency antenna 123. The reader BLE radio frequency unit 121, the reader OOK radio frequency unit 122, and the reader high-frequency antenna 123 use a shared circuit. The reader MCU 1 does not include a reader low-frequency circuit or a reader low-frequency antenna, where the low frequency is less than or equal to 150 KHz. A display unit 13 is electrically connected to the reader input/output module 125. A keyboard 14 that is electrically connected to the reader input/output module 125.

The reader memory unit 11 is used for storing user settings.

The reader main controller 124 is used to coordinate signal transmission and operation between all components within the reader MCU 1.

The 2.4G signal encoding wake-up operation tire pressure detector 2 of the present invention comprises a first TPMS-MCU (21) electrically connected to a first TPMS memory unit 211, a first TPMS communication interface 212, a first TPMS main controller 213, and a TPMS high-frequency transceiver module 214. The TPMS high-frequency transceiver module 214 comprises a TPMS-BLE radio frequency unit 2141, a TPMS-OOK radio frequency unit 2142, and a TPMS high-frequency antenna 2143. The TPMS-BLE radio frequency unit 2141, the TPMS-OOK radio frequency unit 2142, and the TPMS high-frequency antenna 2143 use a shared circuit. The present invention also comprises a second TPMS-MCU 22 electrically connected to a second TPMS memory unit 221, a second TPMS communication interface 222, a second TPMS main controller 223, and the first TPMS-MCU 21. The first TPMS-MCU 21 and the second TPMS-MCU 22 do not contain TPMS low-frequency circuits or TPMS low-frequency antennas. The low frequency is less than or equal to 150 KHz.

The signal transmission mode of the TPMS high-frequency transceiver module 214 is one of BLE (Bluetooth Low Energy), OOK (On-Off Keying), RFID (Radio Frequency Identification), WI-FI, UWB (Ultra-wideband), Zigbee (Zonal Intercommunication Global-standard), and LPWAN (Low-Power Wide-Area Network).

The first TPMS memory unit 211 and the second TPMS memory unit 221 are used to store relevant information related to the matching of the present invention.

The first TPMS communication interface 212 and the second TPMS communication interface 222 are used to implement data transmission between various units of the first TPMS-MCU 21 and the second TPMS-MCU 22 respectively.

The first TPMS main controller 213 is used to coordinate signal transmission and operation between components within the first TPMS-MCU 21.

The second TPMS main controller 223 is used to coordinate signal transmission and operation between components within the second TPMS-MCU 22.

The present invention employs a configured TPMS high-frequency transceiver module 214, which includes the TPMS-OOK radio frequency unit 2142. After matching with the corresponding mobile reader “A” that wakes up the tire pressure detector by using 2.4G signal encoding, the reader OOK radio frequency unit 122 in the mobile reader “A” can be used to transmit signals to the matched present invention using OOK signals. This means that the mobile reader “A”, which wakes up the tire pressure detector by using 2.4G signal encoding, only requires a reader high-frequency antenna 123, and the matched present invention only needs to be equipped with the TPMS high-frequency antenna 2143. There is no need to simultaneously use high-frequency and low-frequency antennas, which is a departure from conventional tire pressure detection systems. In comparison, this invention indeed improves the issue of excessive variety in antenna usage.

The mobile reader “A” that wakes up the tire pressure detector 2 by using 2.4G signal encoding is further detailed. The mobile reader “A”, which wakes up the tire pressure detector by using 2.4G signal encoding, utilizes the reader OOK radio frequency unit 122 to send an OOK signal to wake up the matched 2.4G signal encoding wake-up operation tire pressure detector. The 2.4G signal encoding wake-up operation tire pressure detector responds with its data using radio frequency signals. The mobile reader “A”, which wakes up the tire pressure detector by using 2.4G signal encoding, receives the TPMS return signal via the reader OOK radio frequency unit 122 and displays it on the display unit 13. The keyboard 14 controls the operation and trigger actions of the mobile reader “A”, which wakes up the tire pressure detector by using 2.4G signal encoding. The signal from the reader OOK radio frequency unit 122 can be a specifically encoded OOK signal and is an RF signal. It shares the reader high-frequency antenna 123 with the reader BLE radio frequency unit 121, and it eliminates the need for a reader low-frequency circuit or a reader low-frequency antenna.

The reader OOK radio frequency unit 122 transmits a specifically encoded OOK signal, which, when received by the first TPMS-MCU 21 through RF OOK trigger signal, immediately informs the second TPMS-MCU 22 to read voltage, temperature, pressure, and other data. It then sends this data back to the first TPMS-MCU 21, which is conveyed to this invention through the TPMS high-frequency transceiver module 214 for reception and display. This approach allows for the omission of TPMS low-frequency circuitry and TPMS low-frequency antennas. As a result, when a vehicle is equipped with four 2.4G signal encoding wake-up operation tire pressure detectors, it only requires four TPMS high-frequency antennas 2143, compared to the eight antennas in the traditional design. This not only reduces the variety of antennas and peripheral circuits but also minimizes the signal transmission load and reduces costs, making the product more competitive in the market.

The 2.4G signal encoding mentioned in the specification represents the transmission frequency of the reader OOK radio frequency unit 122 and the TPMS-OOK radio frequency unit 2142.

While we have shown and described the embodiment in accordance with the present invention, it should be clear to those skilled in the art that further embodiments may be made without departing from the scope of the present invention.

What is claimed is:

1. A 2.4G signal encoding wake-up operation tire pressure detector (2) comprising:
a first TPMS-MCU (21) electrically connected to a first TPMS memory unit (211), a first TPMS communication interface (212), a first TPMS main controller (213), and a TPMS high-frequency transceiver module (214);
a second TPMS-MCU (22) electrically connected to a second TPMS memory unit (221), a second TPMS communication interface (222), a second TPMS main controller (223), and the first TPMS-MCU (21), and
wherein the first TPMS-MCU (21) and the second TPMS-MCU (22) do not contain TPMS low-frequency circuits or TPMS low-frequency antennas, the low frequency is less than or equal to 150 KHz.

2. The 2.4G signal encoding wake-up operation tire pressure detector as claimed in claim 1, wherein the TPMS high-frequency transceiver module (214) comprises a TPMS-BLE radio frequency unit (2141), a TPMS-OOK radio frequency unit (2142), and a TPMS high-frequency antenna (2143), the TPMS-BLE radio frequency unit 2141, the TPMS-OOK radio frequency unit 2142, and the TPMS high-frequency antenna 2143 use a shared circuit.

3. The 2.4G signal encoding wake-up operation tire pressure detector as claimed in claim 1, wherein a signal transmission mode of the TPMS high-frequency transceiver module (214) is one of BLE (Bluetooth Low Energy), OOK (On-Off Keying), RFID (Radio Frequency Identification), WI-FI, UWB (Ultra-wideband), Zigbee (Zonal Intercommunication Global-standard), and LPWAN (Low-Power Wide-Area Network).
